(19) United States
(12) Patent Application Publication
(10) Pub. No.: US 2009/0254447 A1
(43) Pub. Date: Oct. 8, 2009

(54) METHODS FOR SELECTION, PURCHASE AND SHIPPING OF ITEMS FOR SALE

(75) Inventor: Rusty A. Blades, Lockbourne, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Global Launch Incorporated, Dublin, OH (US)

(21) Appl. No.: 12/418,878

(22) Filed: Apr. 6, 2009

Related U.S. Application Data
(60) Provisional application No. 61/042,383, filed on Apr. 4, 2008.
(60) Provisional application No. 61/077,545, filed on Jul. 2, 2008.
(60) Provisional application No. 61/151,630, filed on Feb. 11, 2009.

(51) Int. Cl. G06Q 20/00; G06Q 30/00; G06Q 40/00; G06F 17/30

(52) U.S. Cl. 705/26; 705/45; 705/34; 707/3; 705/40; 705/1; 705/27; 707/E17.014; 707/E17.044

(57) ABSTRACT

Methods for the selection, purchase and shipping of items offered for sale. Said methods are enabled by computer software modules that allow a consumer to: (1) pay for items sold through an e-commerce website by using check and cash payment methods; (2) specify a future payment date and a future shipping date for a designated transaction with an e-commerce vendor; (3) specify a price at which the consumer is willing to purchase a particular item offered through an e-commerce website, after which the website crawls the Internet and automatically purchases the item and/or notifies the consumer if the item is found at or below the specified price; (4) arrange a customized installment payment schedule for purchasing items through an e-commerce website; and (5) create and manage a gift registry with an e-commerce vendor with a great degree of flexibility.

### CROSS-REFERENCES TO RELATED APPLICATIONS

This application claims the benefit of U.S. Provisional Application No. 61/042,383 filed Apr. 4, 2008, U.S. Provisional Application No. 61/077,545 filed Jul. 2, 2008, and U.S. Provisional Application No. 61/151,630 filed Feb. 11, 2009, all of which are incorporated herein by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to the arrangement of commercial transactions, and more particularly to various methods for the selection, purchase and shipping of items that are offered for sale by commercial vendors.

2. Description of the Related Art

Conventionally, when a prospective consumer of goods seeks to purchase an item for future use, he or she selects an item and purchases it. The transaction occurs when consideration and the goods change hands. However, the future giving of an item, for example as a gift to another person, requires payment at the time of purchase, and, if the item is available, storage until the time for giving the gift arises. With online sales, there is some uncertainty about availability of the item and whether it will be delivered in time for the future use, or prior to the future use arising. Therefore, the timing of the purchase and delivery of online items can be even more important than in the conventional retail environment.

While some consumers enjoy “shopping”, i.e., searching for items to purchase for the sheer enjoyment of searching, others consider it unpleasant or a necessary irritation. Men, in particular, tend not to enjoy shopping, or the act of spontaneously browsing for and purchasing items as gifts. If this type of person is informed that a friend or relative desires a particular product, he often forgets, by the time the date to purchase a gift for that person arises, what the person has indicated is desired. Thus, if a friend informs another person that he would enjoy having a personal digital assistant (PDA), for example, the person would not normally go immediately to purchase a PDA for the friend unless the time to give the gift is very close. Otherwise, the person may spend money for a gift for someone who is no longer a friend when the time to give the gift comes to pass, or whose tastes have changed and no longer desires a PDA. Additionally, with rapidly changing consumer electronics, the PDA may have been replaced with a newer, and more desirable, version by the time the gift is given, or its price may have dropped. Additionally, that potentially expensive item must be stored until the date it is given, and for people who have little room, or who move in the meantime, this can cause substantial concern. For these and other reasons, consumers rush to purchase gifts for others at times that immediately precede the date the gift is to be given, thereby taking away from the joy of giving gifts in the interest of completing a task.

It is also common for some consumers who desire to purchase items at the present to be unable to afford the entire purchase price of the items. Currently, such consumers can either save up their money and risk the product being sold out when it is needed, or start paying for the item on a “layaway” program or something similar to it. A layaway consumer makes partial installment payments until the total purchase price is received by the seller. The seller generally dictates the amounts of such installment payments and the frequency with which such payments must be made without any consideration given to what is convenient for the consumer. Upon full payment, the seller releases the item to the purchaser. Despite growing sales of products over the Internet, there are no sellers of goods known to the inventor that provide a layaway program for the sale of items over the Internet.

Even under the best of conditions, and assuming none of the above problems exist, some consumers simply do not feel comfortable using traditional Internet payment methods, such as credit card, automatic clearing house (ACH) transfer, and PayPal, to pay for online transactions. This may be because of concerns regarding the safety of transmitting sensitive financial information over potentially unsecure lines of communication. Other consumers simply prefer to remain anonymous when making purchases, which is virtually impossible when using traditional Internet payment methods.

The following reasons, as explained in detail above, summarize why many people do not purchase products on the Internet. First, consumers who do not have the entire amount of the purchase price of the goods cannot make purchases over the Internet unless they use using credit cards, bank transfers, or PayPal-like services. Second, many consumers who have the required purchase amount simply do not need the product at the time. Third, many consumers wait until the last minute to purchase products, because of a concern that the price will drop. Finally, many consumers do not like to purchase products online using credit cards and similar electronic transfers because of security concerns. Consumers would be well served by one or more solutions to these problems.

Another issue, which is perhaps less pronounced than the above, is that many consumers engage in so-called “gift registries” with sellers whereby a consumer identifies a number of items offered by the seller that the consumer would like to receive as gifts from friends and family for a particular gift-giving occasion, e.g., a wedding or a baby shower. A problem commonly associated with gift registries is that gift givers are often unwilling or unable to purchase expensive items for the gift recipient. The recipient is therefore motivated to specify a large number of inexpensive gift items that the recipient anticipates the gift givers are likely to purchase instead of specifying a fewer number of more expensive items that the recipient finds more desirable, even if the total price of the items specified would be the same.

It would therefore be advantageous to have a method for allowing consumers to make online purchases using a flexible installment payment scheme. It would further be advantageous to have a method for allowing consumers to make online purchases using check and cash payment in addition to traditional Internet payment methods. It would further be advantageous to have a method for allowing a consumer to designate a future payment date and a future shipping date for an online transaction. It would further be advantageous to have a method for allowing a consumer to implement a flexible gift registry whereby gift givers would be allowed to make partial payments for gift items and whereby the consumer could allocate such payments among the items.

### BRIEF SUMMARY OF THE INVENTION

In accordance with the present invention, there is provided a plurality of methods for arranging the selection, purchase and shipping of items sold through conventional electronic commerce (“e-commerce”) websites on the Internet. Such websites include traditional “single-vendor” websites (e.g., bestbuy.com, circuitcity.com, nordstrom.com, etc.) that offer items sold by a single e-commerce vendor, as well as “aggregator” websites (e.g., nextag.com, shopping.com, shopmania.com, etc.) that offer or present items sold by a plurality of e-commerce vendors.

The methods of the present invention are preferably enabled by several independent software modules that are incorporated into the architecture of an e-commerce website or the website of a designated third party that facilitates payment processing and/or shipping for an e-commerce vendor. It is preferred that all of the software modules be implemented together, although it is contemplated that fewer than all of the modules can be incorporated into a website. It is further preferred that the software modules be interoperable in a variety of ways that will be become apparent herein.

The methods enabled by a first of the software modules of the present invention (herein referred to as the “Secure Pay” module) allow a consumer who accesses an e-commerce website to pay for items sold through the website by using check and cash payment methods in addition to traditional Internet payment methods (e.g., credit card, Automated Clearing House (ACH) transfer, and PayPal). The term “check” as used herein refers to personal checks, bank checks, certified checks, traveler's checks, and any other type of check that is conventionally used for payment.

To pay for a transaction on an e-commerce website with a check, a consumer first specifies to the website that the consumer would like to make a payment in a specified amount by check. The website then generates a billing document that contains information identifying the transaction and provides the billing document to the consumer in an electronic format. The website then instructs the consumer to print the billing document and to deliver the billing document and a check for the specified amount to a banking affiliate of the vendor. The consumer then delivers (e.g., by mail or by hand) the billing document and the check to the banking affiliate, after which the banking affiliate deposits the check, in association with the transaction, in an account maintained by the e-commerce vendor.

To pay for a transaction on an e-commerce website with cash, a consumer first specifies to the website that the consumer would like to make a payment in a specified amount by cash. The website then generates a payment form that contains information identifying the transaction and provides the payment form to the consumer in an electronic format. The website then instructs the consumer to print the payment form and to deliver the payment form and a check for the specified amount to a conventional MoneyGram agent, such as may be found at many banks, grocery stores, gas stations, and convenience stores. The consumer then delivers the payment form and the cash payment to a MoneyGram agent, after which the MoneyGram agent credits the payment, in association with the transaction, to an account maintained by the e-commerce vendor.

A second aspect of the methods enabled by the Secure Pay module of the present invention allows a consumer to use a plurality of different payment methods to pay an amount due for a single transaction through an e-commerce website. According to this aspect of the invention, a consumer first specifies to a website at least two payment methods (e.g., credit card, ACH transfer, PayPal, check, or cash) that the consumer would like to use to pay a total amount due for a transaction. The consumer then specifies to the website a portion of the total amount due that the consumer would like to pay using one or more of the specified payment methods. If the consumer specifies that he or she would like to pay any amounts by check or cash, such payments are arranged in the manner described above. Other payments by credit card, Pay Pal or other means are processed in a conventional manner. Once the e-commerce vendor has processed each of the payments and has received the total amount due for the transaction, the vendor is then able to ship any items purchased in the transaction to a shipping address specified by the consumer.

The methods enabled by a second of the software modules of the present invention (herein referred to as the “Delay Delivery” module) allow a consumer to specify a future payment date and a future shipping date for a designated transaction through an e-commerce website. A consumer can thereby pay for a transaction and have the items in the transaction shipped whenever it is most convenient for him or her.

In accordance with the methods enabled by the Delay Delivery module, a consumer on a first date specifies to an e-commerce website a second date on which the consumer would like to pay an amount due for a transaction, and the consumer provides means for making such payment (e.g., a credit card number, account and routing numbers for a bank account, etc.). The consumer then specifies to the website a third date on which the consumer would like the vendor to ship said at least one item. The payment for the transaction is then processed on the second date using the payment means provided by the consumer, and any items purchased in the transaction are shipped on the third date. Preferably, the website issues notifications to the consumer in advance of the second date and the third date via means of communication previously specified by the consumer (e.g., e-mail, text message, instant message, fax, desktop widget, etc.).

The methods enabled by a third of the software modules of the present invention (herein referred to as the “Price Watch” module) allow a consumer to specify a price at which he or she is willing to purchase a particular item offered through an e-commerce website. The website subsequently “crawls” the Internet in a conventional manner and automatically purchases the item and/or notifies the consumer if the item is found at or below the price specified by the consumer.

According to a first aspect of the methods enabled by the Price Watch module, a consumer first identifies an item sold through an e-commerce website that is offered at a first price. The consumer then specifies to the website a second price that is less than the first price, and instructs the website to purchase the item if it is found at or below the second price. The consumer then arranges payment in the amount of the second price. The website then crawls the Internet and monitors the price of the item on a plurality of websites and purchases the item if the price is less than or equal to the second price. The consumer is preferably notified of the purchase via means of communication previously specified by the consumer (e.g., e-mail, text message, instant message, fax, desktop widget, etc.). The e-commerce vendor then ships the item to an address previously specified by the consumer.

According to a second aspect of the methods enabled by the Price Watch module, a consumer first identifies an item sold through an e-commerce website that is offered at a first price. The consumer then specifies to the website a second price that is less than the first price, and instructs the website to notify the consumer if the item is found at or below the second price. The website then crawls the Internet and monitors the price of the item. The consumer is notified via means of communication previously specified by the consumer (e.g., e-mail, text message, instant message, fax, desktop widget, etc.) if the item is found at or below the second price, and the consumer is preferably invited to purchase the item.

The methods enabled by a fourth of the software modules of the present invention (herein referred to as the “Layaway” module) allow a consumer to arrange a customized installment payment schedule for purchasing items offered through a vendor's e-commerce website. A consumer can thereby pay for a transaction with a plurality of installment payments and can define the frequency of the installments as well as the payment method used for each installment payment.

According to a first aspect of the methods enabled by the Layaway module, a consumer first specifies to an e-commerce website a first date on which the consumer would like to begin making installment payments for a particular transaction. The consumer then specifies a second date on which the consumer would like the vendor to ship any items involved in the transaction. The consumer then specifies a payment frequency f with which the consumer would like to make installment payments. The website then calculates an installment payment amount P that will allow the consumer to pay a total amount due for the transaction T in a time period t between the first date and the second date, such as by using the equation P=T÷((t÷f)+1). The website then presents the consumer with a payment schedule that instructs the consumer to make installment payments in the calculated payment amount P on the first date and with the payment frequency f thereafter. The consumer preferably specifies a payment method that the consumer would like to use to pay each installment payment. The consumer then makes payments according to the payment schedule. Preferably, the website then issues notifications to the consumer in advance of payment dates via means of communication previously specified by the consumer (e.g., e-mail, text message, instant message, fax, desktop widget, etc.). After the consumer makes all of the installment payments, the e-commerce vendor ships the items involved in the transaction on or after the second date.

According to a second aspect of the methods enabled by the Layaway module, a consumer first specifies to an e-commerce website a first date on which the consumer would like to begin making installment payments for a particular transaction. The consumer then specifies an installment payment amount P that the consumer would like to pay for each installment payment. The consumer then specifies a payment frequency f with which the consumer would like to make installment payments. The website then calculates an amount of time t it will take for the consumer to pay a total amount due for the transaction T, such as by using the equation t=(ceiling (T÷P)−1)×f; where “ceiling” denotes the ceiling function (indicating that the result of “T÷P” should be rounded to the next greatest integer). The website then presents the consumer with a payment schedule that instructs the consumer to make installment payments in the payment amount P on the first date and with the payment frequency f thereafter until, but not including, a second date that is removed from the first date by the amount of time t. The consumer is additionally instructed to make a final installment payment on the second date in an amount equal to the total amount due T reduced by the sum of the installment payments that are to be paid before the second date. The consumer preferably specifies a payment method that the consumer would like to use to pay each installment payment. The consumer then makes payments according to the payment schedule. Preferably, the website issues notifications to the consumer in advance of payment dates via means of communication previously specified by the consumer (e.g., e-mail, text message, instant message, fax, desktop widget, etc.). After the consumer makes all of the installment payments, the e-commerce vendor ships the items involved in the transaction on or after the second date.

According to a third aspect of the methods enabled by the Layaway module, a consumer first specifies to an e-commerce website a total number of installment payments that the consumer would like to make to pay for a particular transaction. The consumer then specifies a payment date for each of the installment payments. The consumer then specifies a payment amount for each of the installment payments, wherein a sum of all the payment amounts equals a total amount due for the transaction. The consumer specifies a payment method that the consumer would like to use to pay each of the installment payments. The consumer then makes payments according to the payment schedule. Preferably, the website issues notifications to the consumer in advance of payment dates via means of communication previously specified by the consumer (e.g., e-mail, text message, instant message, fax, desktop widget, etc.). After the consumer makes all of the installment payments, the e-commerce vendor ships the items involved in the transaction.

The methods enabled by a fifth of the software modules of the present invention (herein referred to as the “Gift Registry” module) allow a consumer (referred to in this context as the “registrant”) to create and to manage a gift registry through an e-commerce website with a great degree of flexibility. A registrant can specify the shipping dates of items in a gift registry and can allocate funds among such items in any manner desired. Additionally, those who contribute to a gift registry (referred to as “invitees”) are able to contribute less than the full price of an item in a gift registry, and are also able to contribute a specified amount of money to a general “registry fund” which can then be allocated by the registrant to various items in the registry.

According to a first aspect of the methods enabled by the Gift Registry module, a registrant first identifies to an e-commerce website items offered, through the website, that the registrant would like to receive as a gift. The registrant then specifies a shipping date on which the registrant would like the items to be shipped. The registrant then provides the e-mail addresses of a plurality of invitees who the registrant would like to participate in the gift registry. The website then issues e-mail invitations to the invitees to participate in the gift registry. A hyperlink to a webpage displaying the items in the registrant's gift registry is preferably provided within the e-mail invitations. Upon visiting the registry web page, each invitee is presented with a first option of paying a full amount of a purchase price of each item, and a second option of paying a partial amount of the purchase price of each item. Using these options, the invitees then make partial or full payments toward the purchase of items in the gift registry. The website then decreases the purchase prices of the items in the registry by any amounts paid toward the items' purchase and displays the decreased purchase prices to invitees who subsequently view the registry web page. Upon the arrival of the specified shipping date, the e-commerce vendor ships any items for which the entire purchase was paid.

At any time prior to shipping, a registrant can preferably move funds paid toward the purchase of any item to a payment toward the purchase of any other item. A registrant can preferably also elect to receive any funds paid toward the purchase of items in the registry as a monetary payment.

According to a second aspect of the methods enabled by the Gift Registry module, an invitee can preferably elect to make a monetary contribution to a general “registry fund” instead of making a payment toward the purchase of an item in the registry. The registrant can then allocate money in the registry fund to payments toward the purchase of items in the registry as he or she desires. A registrant can preferably also elect to receive money in the registry fund as a monetary payment.

### BRIEF DESCRIPTION OF THE SEVERAL VIEWS OF THE DRAWINGS

FIG. 1 is a flowchart illustrating methods enabled by an embodiment of the Secure Pay module of the present invention.

FIG. 2 is a flowchart illustrating methods enabled by an embodiment of the Delay Delivery module of the present invention.

FIG. 3 is a flowchart illustrating methods enabled by an embodiment of the Price Watch module of the present invention.

FIG. 4 is a flowchart illustrating methods enabled by an embodiment of the Layaway module of the present invention.

FIG. 5 is a flowchart illustrating methods enabled by an embodiment of the Gift Registry module of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

The present invention includes methods for providing consumers with a variety of customizable payment and delivery options when purchasing items and contributing funds through electronic commerce (“e-commerce”) websites. Items include any goods normally sold in a conventional retail store or over the Internet, including, but not limited to, apparel, consumer electronics, sporting goods, appliances, home décor, furniture, tools, books, musical recordings, films, etc.

The methods of the invention are preferably implemented by a set of independent computer software modules that can be incorporated into the architecture of conventional e-commerce websites, including aggregator websites, either directly (e.g., by incorporating the software modules into the HTML code stored on a server that hosts a vendor's e-commerce website) or indirectly (e.g., by incorporating the software modules into the HTML code stored on a server that hosts the website of a third-party payment processor that is linked to the e-commerce website). The software modules can be implemented on a vendor's e-commerce website independently or as an interoperable package containing any practical combination or subset of modules desired, as will be described in greater detail below.

Various communications and interactions between e-commerce websites and consumers will be described herein. Such communications and interactions are facilitated by conventional network access means that may include wired and wireless Internet connections, voice and data telecommunications connections, in-store systems, in-locale systems, and kiosk systems. Although one form of communication or interaction is specified, a person of ordinary skill will understand how to use other forms as a substitute. Thus, when one form is described, the reader should note that others are contemplated.

The individual software modules of the invention, each of which contain numerous procedures for facilitating specific interactions between vendors and consumers, are herein referred to as Secure Pay, Price Watch, Layaway, Delay Delivery, and Gift Registry, although the particular names of the modules are not critical to the invention and are employed for reference only. It will be understood by persons having ordinary skill in the art that the methods enabled by the software modules can be used in other, non-software applications, and that the software modules can be modified and enhanced in such ways as to change their functionality while retaining the essential elements of the invention. The particular software language and software code used to implement the methods embodied by the software modules described herein are not critical to the invention and will therefore not be described in detail. The methods enabled by each module will now be discussed in-turn.

Secure Pay

A first aspect of the methods enabled by the Secure Pay module of the present invention allows online consumers to pay for items sold through e-commerce websites by using check and/or cash payment in addition to traditional Internet payment methods, such as credit card, Automated Clearing House (ACH) transfer, and PayPal. Consumers who are wary of transmitting personal information such as billing addresses, credit card numbers and bank account numbers over an electronic network are thereby provided with anonymous, “offline” means for paying for online transactions.

The initial progression of a conventional commercial transaction between a consumer and an e-commerce vendor typically involves a consumer using a network enabled device, such as a properly configured personal computer, personal data assistant (PDA), cellular telephone, WebTV, game console, or in-store kiosk to access the website of an e-commerce vendor on the Internet, typically through the use of a conventional Internet browsing application such as Mozilla Firefox, Microsoft Internet Explorer, or Apple Safari. The consumer then browses or searches the vendor's inventory, which is commonly represented by a categorized array of representative photographs of items that are arranged on a plurality of linked web pages on the vendor's website. Each representative photograph is typically accompanied by a brief written description and a specification summary.

While browsing the vendor's inventory the consumer notes items of interest and may add such items to a virtual “shopping bag” or “shopping cart” on the vendor's website, such as by selecting an “add to shopping cart” option from a drop down menu adjacent the item. The item is then transferred to the consumer's shopping cart in a conventional manner where it is held for later consideration or purchase, or until the consumer removes the item from the shopping cart.

Once the consumer is satisfied with his or her selections and has decided to purchase the items contained in the shopping cart, the consumer instructs the vendor's website to advance to a “checkout” phase of the transaction, typically by clicking a hyperlink labeled “Checkout,” “Proceed to Checkout,” “Purchase,” or some variation thereof. The consumer is then typically instructed to provide the vendor website with user account login information if they have not already logged into a user account on the website. If the consumer does not have a registered user account with the vendor, he or she may be presented with the option of registering a user account by providing certain personal information, such as a name, a password, an email address, and a physical address.

After the consumer has performed the necessary steps for advancing to the checkout phase of the transaction, the methods enabled by the Secure Pay software module of the invention are initiated and the consumer is directed to a separate payment processing portion of the vendor's website. Alternatively, if the vendor has enlisted a third party to handle payment processing for the vendor's online transactions, the consumer is directed to the third party's payment processing website, wherein the server that hosts the third party's website is capable of implementing the methods enabled by the Secure Pay software module.

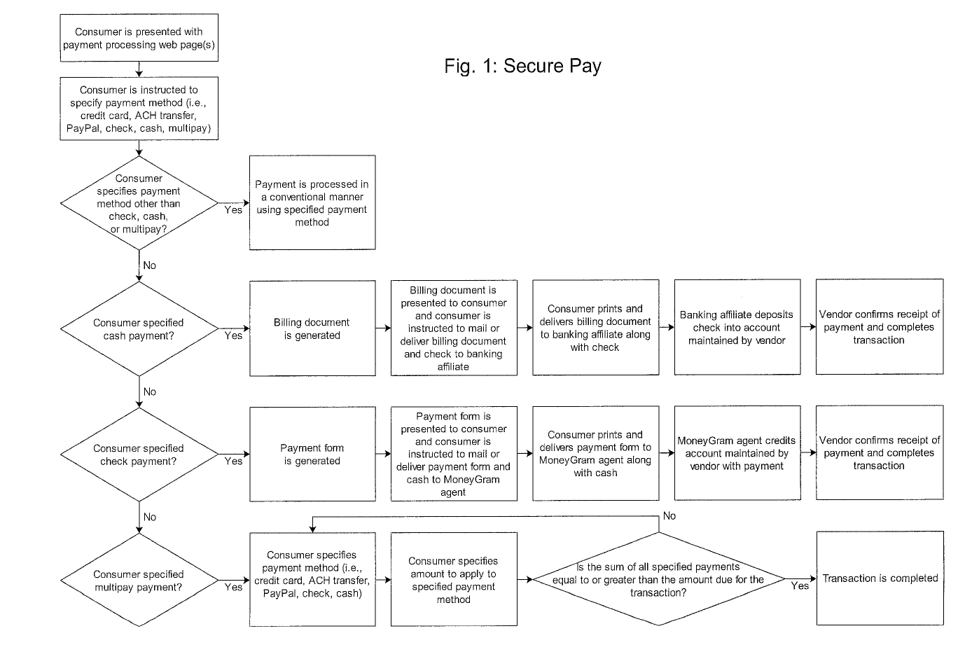

Referring to the flowchart shown in FIG. 1, the consumer is presented with a web page, or a series of linked web pages, that are substantially similar in appearance to the payment processing web pages found on many conventional e-commerce websites, such as Amazon.com or Buy.com. That is, the consumer is presented with at least one web page having a plurality of blank fields into which the consumer is directed to enter his or her shipping address, billing address, email address, and phone number, as well as any promotional codes, coupon codes, gift certificate codes, and other information that is relevant to completing the transaction with the vendor. If the consumer maintains a user account with the vendor and has logged into his or her user account before being directed to the payment processing portion of the website, some of the fields may be automatically populated with information retrieved from the consumer's user account (e.g., from a database maintained on the host server of the vendor where user account information is stored).

The consumer is also presented with a list of the items being purchased, including each item's price, a sub-total amount for the transaction, the amounts of any coupons, gift certificates, or promotional discounts that have been applied to the transaction, shipping and handling fees, the amount of any applicable taxes, and a grand total amount for the transaction. Additionally, the consumer is presented with a variety of shipping options, preferably including a plurality of shipping providers and corresponding shipping methods, such as UPS Ground, UPS Next Day Air, FedEx Ground, FedEx Same Day, etc.

After the grand total amount due for the transaction is calculated (including applicable taxes, shipping fees, coupons, etc.), the consumer is presented with a menu of payment options for paying the amount due. The payment options preferably include credit card, ACH transfer, PayPal, cash, check, and “multipay” (described below), although it is contemplated that various other conventional payment methods can additionally be offered to consumers through the Secure Pay module. Each payment method is preferably represented by a separate hyperlink on the payment processing web page(s). Upon clicking on one of the hyperlinks, the consumer is instructed to provide additional information required for completing the transaction using the selected payment method (e.g., bank account and routing numbers for payment by ACH transfer, PayPal login information for PayPal payment, a credit card number and expiration date for credit card payment, etc.) and is provided with designated fields for entering the requested information. Again, such information can be automatically retrieved if it is available from the consumer's online user account maintained by the vendor. Since methods for procuring online payment using credit cards, ACH transfers, and PayPal are well known and are implemented by the Secure Pay module in a conventional manner, only the features of the Secure Pay module that enable check and cash payment methods will be described in greater detail below.

If the consumer selects the check payment option provided by the Secure Pay module, the Secure Pay module then generates a billing document, preferably in Microsoft Word document format (.doc) or Adobe printable document format (.pdf), that contains information relevant to the transaction. Such information preferably includes the vendor's name and/or an account number associated with the vendor, an order number identifying the transaction, the consumer's name and contact information, and the total amount of money due on the transaction. The billing document preferably also includes a list of any items being purchased including each item's price, a sub-total amount for the transaction, the amounts of any coupons, gift certificates, or promotional discounts that have been applied to the transaction, the shipping provider and shipping method selected by the consumer, shipping and handling fees, and any applicable taxes.

The billing document is presented to the consumer and the consumer is instructed to print the billing document. It is contemplated that a properly configured printing device that is connected to the consumer's network enabled device can additionally or alternatively be automatically instructed to print the billing document. The consumer is instructed to mail or deliver the printed billing document to the address of a designated banking affiliate of the vendor (i.e., a bank at which the vendor maintains a deposit account) along with a check or other financial instrument in the amount of at least the total due on the transaction.

An electronic copy of the billing document is stored on the vendor's host server so that it can be conveniently retrieved at a later time. It is contemplated that the consumer can alternatively or additionally be provided with the option of downloading the electronic file containing the billing document to the consumer's network enabled device so that the billing document can be electronically stored thereon and printed at a later time. It is further contemplated that the billing document can alternatively or additionally be mailed or e-mailed to the consumer with printing and mailing instructions contained therein.

Next, in accordance with the instructions provided to the consumer, the consumer prints the billing document (if it was not previously printed automatically) and mails or otherwise delivers the printed document to the address of the vendor's banking affiliate with a check for the amount due on the transaction. Upon receiving the billing document and the check, the banking affiliate deposits the check into a deposit account maintained by the vendor, noting the name of the payor (i.e., the consumer) and the order number associated with the transaction. After the vendor verifies that the consumer has made a payment in the proper amount (e.g., by comparing the deposited amount with the grand total on the appropriate billing document stored on the vendor's server), the vendor e-mails or otherwise sends a receipt to the consumer and completes the transaction, such as by processing and shipping the purchased items in a conventional manner or in accordance with the methods described herein.

If the consumer selects the cash payment option provided by the Secure Pay module, the Secure Pay module generates a payment form, preferably in Microsoft Word document format (.doc) or Adobe printable document format (.pdf), that contains information relevant to the transaction. Like the billing document described above, the payment form preferably includes the vendor's name and/or an account number associated with the vendor, an order number, the consumer's name and contact information, and the total amount of money due on the transaction. The payment form preferably also includes a list of any items being purchased including each item's price, a sub-total amount for the transaction, the amounts of any coupons, gift certificates, or promotional discounts that have been applied to the transaction, the shipping provider and shipping method selected by the consumer, shipping and handling fees, and any applicable taxes.

The payment form is presented to the consumer and the consumer is instructed to print the payment form. It is contemplated that a properly configured printing device that is connected to the consumer's network enabled device can additionally or alternatively be automatically instructed to print the payment form. The consumer is instructed to deliver the printed payment form, along with a cash payment in the amount of the total due on the transaction, to a participating cash processing agent, such as a MoneyGram agent located at a bank, convenience store, gas station, or check cashing store that provides conventional MoneyGram payment processing. The consumer is preferably also provided with the addresses of MoneyGram locations in the consumer's geographical area and is presented with a map showing such locations. Of course, MoneyGram is one of many examples of third party service providers, such as banks or Western Union, among others, that can provide this service.

An electronic copy of the payment form is stored on the vendor's host server so that it can be conveniently retrieved at a later time. It is contemplated that the consumer can alternatively or additionally be provided with the option of downloading an electronic file containing the payment form to the consumer's network enabled device so that the form can be electronically stored thereon and printed at a later time. It is further contemplated that the payment form can alternatively or additionally be mailed or e-mailed to the consumer with printing and mailing instructions contained therein.

Next, in accordance with the instructions provided to the consumer, the consumer prints the payment form (if it was not previously printed automatically) and delivers the printed form to a MoneyGram location of the consumer's choosing, along with a cash payment for the amount due on the transaction. Upon receiving the payment form and the cash, the MoneyGram processor credits a MoneyGram account maintained by the vendor, noting the name of the payor (i.e., the consumer) and the order number associated with the transaction, and provides the consumer with a receipt. After the vendor verifies that the consumer has made a payment in the proper amount (e.g., by comparing the credited amount of the MoneyGram payment with the grand total on the appropriate payment form stored on the vendor's server), the vendor e-mails or otherwise sends another receipt to the consumer and completes the transaction in a conventional manner or in accordance with the methods described herein.

Another payment option enabled by the Secure Pay module, herein referred to as “multipay” for convenience, allows a consumer to use a plurality of different payment methods to pay for a single transaction. That is, a consumer can pay the amount due for a particular transaction using any or all of the payment methods offered by the Secure Pay module, including credit card, ACH transfer, PayPal, check, and cash. A consumer can additionally specify any monetary amount desired to be applied to each of the selected payment methods.

Still referring to the flowchart shown in FIG. 1, if a consumer selects the “multipay” payment option, such as by clicking a hyperlink labeled “MultiPay,” “Use Multiple Payment Methods,” or some variation thereof, then the consumer is instructed to specify a first desired payment method (excluding the multipay option) in the manner described above. The consumer is then instructed to specify an amount of the total amount due for the transaction that the consumer would like to apply to the first selected payment method, such as by entering the amount into a designated field on the web page. If the consumer enters an amount that is equal to the full amount due on the transaction, the rest of the transaction is processed in the manner described above and the transaction is completed.

Alternatively, if the consumer specifies an amount to be applied to the first desired payment method that is less than the full amount due on the transaction, then the payment is processed in the manner described above only for the specified amount, thus leaving a balance due on the transaction. The consumer is then presented with an updated grand total amount due on the transaction that is equal to the original grand total amount reduced by the amount applied to the first selected payment method. The consumer is again provided with the selection of available payment methods described above.

Next, the consumer selects a second desired payment method from the available options for paying all or a portion of the remaining balance for the transaction. The consumer can select a payment method that is different from first selected payment method, or he or she can select the same payment method again (e.g., if the consumer wishes to use more than one credit card, bank account, or PayPal account to pay the amount due on the transaction). The consumer is then instructed to specify an amount of the updated grand total amount due that he or she would like to apply to the second selected payment method, such as by entering the amount into a designated field on the web page. Again, if the consumer enters an amount equal to the entire remaining balance for the transaction, then the rest of the transaction is processed in the manner described above and the transaction is completed.

Alternatively, if the consumer specifies an amount to be applied to the second selected payment method that is less than the entire remaining balance amount for the transaction, then the payment is processed in the manner described above only for the specified amount. The process of making such partial payments repeats in a loop-like fashion until the sum of all of the partial payment amounts made by the consumer equals the total amount due on the transaction, after which the items purchased through the transaction are processed and shipped in a conventional manner or in accordance with the methods described herein.

Delay Delivery

The methods enabled by the Delay Delivery module of the present invention allow a consumer to specify a future payment date and a future shipping date for a designated transaction. For example, a consumer can specify a future payment date and a future shipping date for a particular item that is to be given as a gift on a future occasion, and the item will be subsequently purchased on the specified payment date and shipped on the specified shipping date without further direction from the consumer. The consumer is thereby relieved from having to remember to purchase the gift for the future occasion, and is also relieved from having to store the gift in advance of the occasion. Furthermore, the consumer can provide payment for the item whenever it is most convenient without having to remember to make the payment.

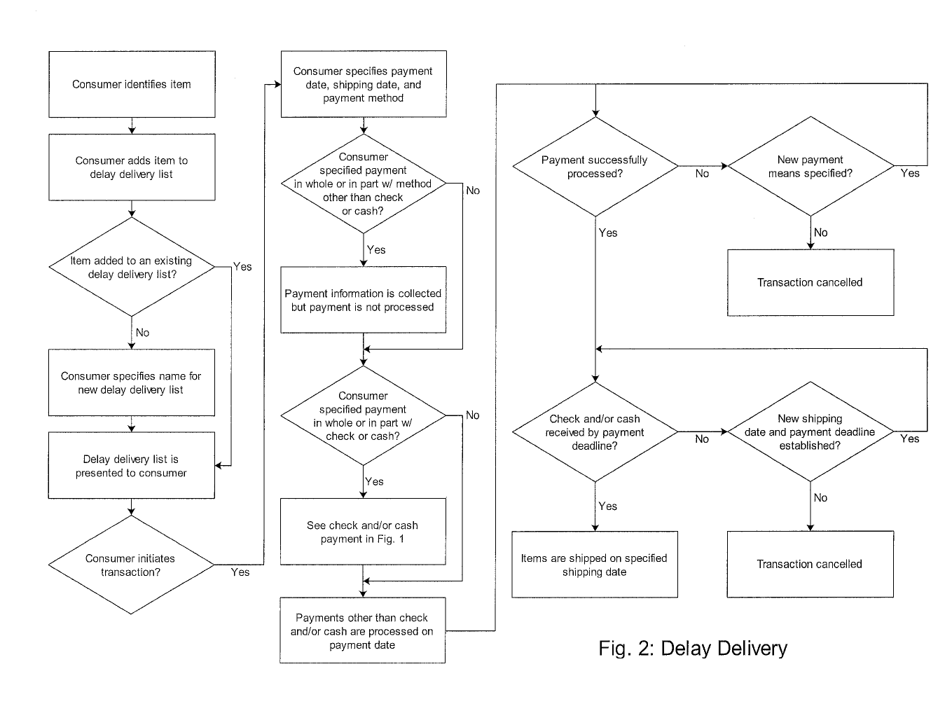

Referring to the flowchart shown in FIG. 2, to utilize the methods enabled by the Delay Delivery module a consumer first identifies an item for which the consumer would like to schedule a future payment date and/or a future shipping date, such as an item displayed on an e-commerce website as part of a vendor's inventory or an item listed in the consumer's shopping cart (described above). The consumer then specifies that he or she would like to add the item to a “delay delivery list” (defined below), such as by selecting an option labeled “add to new Delay Delivery List” or some variation thereof in a drop down menu adjacent the item (preferably the same drop down menu that offers the “add to shopping cart” option described above). The consumer is then instructed to specify a reference name for a new delay delivery list (e.g., “Anniversary Present,” “Mother's Day Gift,” etc.), such as by entering the reference name into a designated field on the web page. Alternatively, the consumer can add the specified item to an existing delay delivery list, such as by selecting the name of a previously established delay delivery list from the same drop down menu described above.

A “delay delivery list” is a group of one or more items offered by the vendor that the consumer would like to purchase and have shipped as part of a single transaction. A consumer can create multiple delay delivery lists for arranging a plurality of different transactions. Each delay delivery list is preferably maintained on the vendor website's host server in association with a particular consumer's user account.

Still referring to the flowchart in FIG. 2, the item selected is added to the delay delivery list designated by the consumer (new or existing), and the consumer is forwarded to a separate web page where the newly added item and any preexisting items associated with the designated delay delivery list are displayed. The web page preferably also displays the price of each item and the total price for all of the items in the list in the manner of a conventional shopping cart web page. The consumer is presented with the option of returning to a web page displaying the inventor's inventory (e.g., to continue shopping), such as by clicking a hyperlink labeled “Continue Shopping,” “Return,” or some variation thereof. Alternatively, the consumer can initiate a transaction for the items in the delay delivery list, such as by clicking a hyperlink labeled “Continue,” “Proceed,” “Purchase,” or some variation thereof.

If the consumer initiates a transaction, the consumer is instructed to specify a desired payment date and a desired shipping date for the transaction, which can be responded to by entering such dates into designated fields on the web page, or by using conventional interactive calendar applets on the web page. Preferably, the consumer will be required to select a payment date that falls on or before the selected shipping date. For example, if the consumer enters a payment date that falls after the selected shipping date, an error message can be displayed notifying the consumer that he or she must change the entered payment date or shipping date.

Next, the consumer is required to specify a shipping address where he or she would like the items in the delay delivery list to be sent, and this can be responded to by entering the address into a designated field on the web page. Alternatively, a shipping address that is associated with the consumer's user account can be retrieved, and the consumer can be required to verify or edit the address. The consumer is instructed to specify a payment method (e.g., credit card, ACH transfer, PayPal, cash, or check) and a shipping method for the transaction.

If the consumer specifies that he or she would like to pay for the transaction in whole or in part with credit card, ACH transfer, or PayPal, then the consumer's relevant payment information (e.g., credit card number, bank account number, routing number, etc.) is collected. The payment for the transaction is not processed, however, until the arrival of the payment date specified by the consumer. For example, if the consumer specifies that he or she would like to pay for the transaction with a card credit, the credit card will not be charged until the specified payment date. If the payment is successfully processed on the specified payment date, the items in the delay delivery list are shipped to the specified shipping address on the specified shipping date (assuming any partial cash or check payments have also been received, as described below). If the payment is not successfully processed (e.g., a specified credit card is declined, sufficient funds are not available in a specified bank account, etc.) the transaction is cancelled and the associated delay delivery list is deleted. Alternatively, the consumer can be provided with notice of the unsuccessful payment and an opportunity to specify a different payment means for the transaction.

If the consumer specifies that he or she would like to pay for the transaction in whole or in part with check or cash, the consumer is provided with an appropriate billing document or payment form in the manner described in the Secure Pay section above. The consumer is also notified that the check or cash payment must be received on or before the consumer's specified shipping date, or by a specified number of days prior to the consumer's specified shipping date as dictated by the vendor, thus establishing a payment deadline. If the vendor receives the check or cash payment by the stated payment deadline, along with any other partial payments that may be required, the items in the delay delivery list are shipped to the consumer's specified shipping address on the specified shipping date. If the complete payment is not received by the payment deadline, the transaction is cancelled and the associated delay delivery list is deleted. Alternatively, the consumer can be provided with notice and an opportunity to specify a new shipping date for the transaction, thereby establishing a new payment deadline. It should be noted that the payment date specified by the consumer is irrelevant with respect to check and cash payments because such payments are submitted by the consumer at his or her discretion, i.e., they are not automatically processed by the vendor on a specified date as with other payment methods.

A consumer can access and edit any of his or her established delay delivery lists at any time before one or more of the items on a list are processed and shipped, such as by logging into his or her online user account with a vendor and clicking on hyperlink labeled “View Delay Delivery Lists” or some variation thereof. For example, a consumer can add or remove items from a list, or can delete a list entirely, thus terminating the transaction associated with the list. If a consumer removes an item from a delay delivery list after the payment for the list's associated transaction has been processed or collected, the price of the removed item is preferably refunded to the consumer without penalty. If a consumer deletes a delay delivery list after the payment for the list's associated transaction has already been processed or collected, the amount paid on the transaction is preferably refunded to the consumer without penalty.

Additionally, a consumer can change the payment date, shipping date, payment means, and shipping method associated with a delay delivery list. A consumer can also preferably specify that he or she would like to be provided with notifications on or in advance of scheduled payment and shipping dates via forms of communication specified by the consumer, such as by e-mail, text message, instant message, fax, or desktop widget (in which case the consumer is provided with a conventional, downloadable widget application that communicates directly with the Delay Delivery module).

A further aspect of the Delay Delivery module of the present invention allows a consumer to take advantage of price reductions for items in his or her delay delivery lists before such items are shipped. For example, if the methods enabled by the Delay Delivery module are incorporated into a single-vendor website, the website will continuously or periodically monitor the prices of items offered on the vendor's website that are in a consumer's delay delivery list. If the methods enabled by the Delay Delivery module are incorporated into an aggregator website, the website continuously or periodically “crawls” the Internet in a conventional manner (e.g., using so-called “web crawling” software that will be familiar to those skilled in the art) and monitors the prices of items offered through other e-commerce websites, and preferably e-commerce websites belonging to merchants that are affiliates of the vendor, that are in a consumer's delay delivery list. If the price of an item in a consumer's delay delivery list is reduced on either the vendor's website or an affiliate's website at any time after the item is added to the delay delivery list but before the item is shipped (or before a predetermined time prior to the specified shipping date, as dictated by the vendor) then the price of the item in the consumer's delay delivery list is reduced by the same amount. If the price of an item in the consumer's delay delivery list is reduced after the payment for the item has already been processed or collected, then the consumer is preferably refunded the difference between the amount paid for the item and the item's reduced price.

Price Watch

The methods enabled by the Price Watch module of the present invention allow a consumer to specify a price at which they are willing to purchase a particular item. The item is then automatically purchased and/or the consumer is notified if the item is found at or below the specified price. The methods enabled by the Price Watch module are best suited for incorporation into the architecture of aggregator websites for reasons that will become apparent below, although it is contemplated that the methods can be incorporated into the architecture of conventional single vendor e-commerce websites as well.

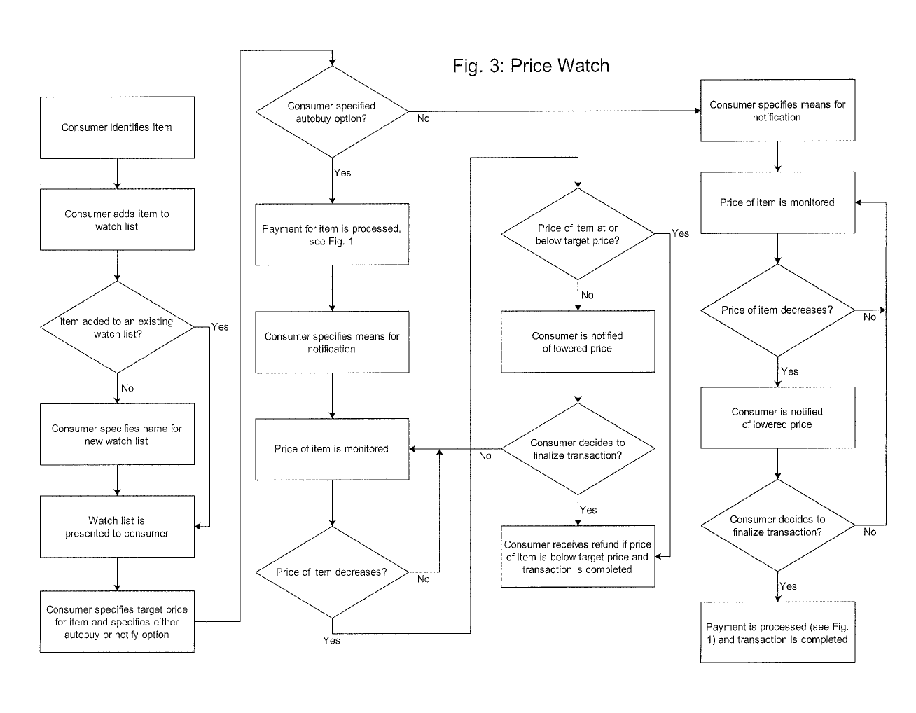

Referring to the flowchart shown in FIG. 3, to utilize the methods enabled by the Price Watch module a consumer first identifies an item that is offered at a price greater than that which the consumer is willing to pay for the item (hereafter referred to as the “initial price”). This item can be an item displayed on an e-commerce website as part of a vendor's inventory, or an item listed in the consumer's shopping cart (described above). The consumer specifies that he or she would like to add the item to the consumer's “watch list” (defined below), such as by selecting an option labeled “add to new Watch List” or some variation thereof in a drop down menu adjacent the item. Preferably this drop down menu will be the same drop down menu that offers the “add to shopping cart” and “add to new Delay Delivery List” options described above. The consumer is then instructed to specify a reference name for a new watch list, such as by entering the reference name (e.g., “Camera Equipment,” “Work Wardrobe,” “Office Supplies,” etc.) into a designated field on the web page. Alternatively, the consumer can add the specified item to an existing watch list, such as by selecting the name of a previously established watch list from the same drop down menu described above.

A “watch list” is a grouping of one or more items offered by the vendor, each of which the consumer wishes to purchase at a first price (hereafter referred to as the “target price”) that is lower than a second price (hereafter after referred to as the “initial price”) at which the item was offered to the consumer at the time the item was added to the watch list. A consumer can create multiple watch lists for managing a plurality of different transactions. Each watch list is preferably maintained on the vendor website's host server in association with a particular consumer's user account.

Still referring to the flowchart in FIG. 3, the item is added to the watch list designated by the consumer (new or existing), and the consumer is forwarded to a separate web page where the newly added item and any preexisting items associated with the designated watch list are displayed. The web page preferably also displays the current price of each item and the total price for all of the items in the list in the manner of a conventional shopping cart web page.

The consumer is next instructed to specify a target price for the item, such as by entering a number into a designated field on the web page. The consumer is also instructed to specify one of the following two actions that the consumer would like to be performed if the item is found at or below the target price: (1) automatically purchase the item; or (2) notify the consumer. If the consumer specifies the first option, such as by selecting an option labeled “AutoBuy,” “Automatically purchase item,” “Buy item when found at target price,” or some variation thereof from a drop down menu adjacent the item, then the consumer is asked to specify desired forms of notification, such as e-mail, text message, instant message, fax, or desktop widget (in which case the consumer will be provided with a conventional, downloadable widget application that communicates directly with the Price Watch module, and preferably the same widget application described above). A payment in the amount of the target price is then collected from the consumer in the manner described in the Secure Pay section above.

Alternatively, the consumer can specify the second option, such as by selecting an option labeled “Notify,” “Notify when found at target price,” or some variation thereof from a drop down menu adjacent the item. The consumer is asked to specify a desired form of notification, such as e-mail, text message, instant message, fax, or desktop widget (in which case the consumer will be provided with a conventional, downloadable widget application that communicates directly with the Price Watch module, and preferably the same widget application described above). The consumer will then simply be notified at the appropriate time.

Next, if the methods enabled by the Price Watch module are incorporated into a single-vendor website, the website will continuously or periodically monitor the price of the item on the vendor's website. If the methods enabled by the Price Watch module are incorporated into an aggregator website, the website continuously or periodically “crawls” the Internet in a conventional manner (e.g., using so-called “web crawling” software that will be familiar to those skilled in the art) and monitors the price of the item offered through other e-commerce websites and preferably e-commerce websites belonging to merchants that are affiliates of the vendor.

If the item is offered for sale through the vendor's website or through an affiliate's website at or below the target price, then the consumer's previously specified instruction to either purchase the item or issue a notification is acted upon. For example, if the consumer previously specified that the item should be automatically purchased at or below the target price, then the item is purchased using the funds previously collected from the consumer (as described above). If the item is purchased at a price that is lower than the target price, the consumer is refunded the difference between the purchase price and the amount previously paid (i.e., the target price), preferably using the same form(s) of payment used by the consumer to pay for the transaction (e.g., by crediting the consumer's credit card account, by issuing a check to the consumer, etc.). The item is then processed and shipped and the consumer is preferably notified of the purchase and shipment via the means of communication previously specified by the consumer (i.e., text message, instant message, e-mail, desktop widget, etc.). The consumer is preferably also notified of the purchase and shipment with an update that appears to the consumer upon logging into his or her user account on the vendor's website.

If the consumer previously specified that he or she would only like to be notified when the item is found at or below the target price, then the price of the item in the watch list is updated to reflect the new, lower price and a notification of the new price is issued to the consumer via the means of communication previously specified by the consumer (i.e., text message, instant message, e-mail, desktop widget, etc). The consumer is preferably also notified of the new price upon logging into his or her user account on the vendor's website. Such notification preferably provides the user with a hyperlink or URL address that directs the consumer to a web page displaying the relevant watch list. Alternatively, it is contemplated that the consumer can be provided with a hyperlink or URL address that directs the consumer to the payment processing portion of the vendor's website (or to the website of a third party payment processor) where the consumer can pay for the item and arrange shipping.

If the item is offered at a price (hereafter referred to as the “lowered priced”) that is lower than the initial price but higher than the target price, then a notification of the lowered price is preferably issued to the consumer via the means of communication previously specified by the consumer. The consumer is preferably also notified of the lowered price with an update that appears to the consumer upon logging into his or her user account on the vendor's website. Such notification is provided because the consumer may decide to purchase the item at the lowered price if, for example, the lowered price is only marginally higher than the target price, or if the consumer's financial situation has changed since he or she designated the target price. The notification preferably provides the user with a hyperlink or URL address that directs the consumer to a web page displaying the relevant watch list. Alternatively, it is contemplated that the consumer can be provided with a hyperlink or URL address that directs the consumer to the payment processing portion of the vendor's website, or to the website of a third party payment processor, where the consumer can pay for the item and arrange shipping. If the consumer does not wish to purchase the item at the lowered price, he or she can simply ignore the notification. The consumer is preferably provided with the option of activating or deactivating such “lowered price notifications” when an item is initially added to his or her watch list or at any time thereafter.

A consumer can access and edit any of his or her established watch lists at any time before the items on a list are shipped, such as by logging into his or her online user account with a vendor and clicking on hyperlink labeled “View Watch Lists” or some variation thereof. For example, a consumer can add or remove items from a list or delete a list altogether. If a consumer deletes a watch list after the consumer has already provided funds for the purchase of any items on the list (i.e., paid any target prices), then the amounts paid are preferably refunded to the consumer without penalty. If the consumer removes an item from the watch list which the consumer had previously instructed the Price Watch module to automatically purchase at a target price (i.e., and provided payment for in the amount of the target price), then the amount paid is preferably refunded back to the consumer without penalty. Alternatively, an amount previously paid by the consumer can be applied to a different transaction, for example, the balance can be applied to the purchase of a recently released, newer model of a removed item. Removing an item from a watch list will cause the Price Watch module to cease its crawling function with regard to the item, although the Price Watch module will continue to crawl for any other items that remain on the watch list in the manner described above.

The consumer can also finalize a transaction for a watch list at any time regardless of the then-current price of the items on the watch list, such as by clicking a hyperlink labeled “Purchase,” “Proceed,” “Continue,” or some variation thereof on the web page displaying the watch list. If a consumer finalizes a transaction for a watch list, then a payment for the items on the watch list is preferably executed in the manner described in the Secure Payment section above. The amount of the payment is equal to the total of the then-current prices of items on the watch list reduced by any amounts already paid by the consumer (excluding the amounts of shipping fees, taxes, discounts, etc). For example, a consumer created a watch list containing a first item with an initial price of $50.00 and a target price of $40.00, and a second item with an initial price of $100.00 and a target price of $60.00. The consumer specified the “notice” option for the first item and the “autobuy” option for the second item, and the price of the first item dropped to $30.00 and the price of the second item dropped to $80.00. If the consumer decides to finalize the transaction for the watch list, the total amount due for the items will be $50.00 ($30.00 for the first item+$80.00 for the second item−$60.00 already paid). After the consumer provides payment, the items are processed and shipped.

A further aspect of the methods enabled by the Price Watch module is a form of “price assurance.” If the price of an item on a watch list rises above the item's initial price, the item is preferably still offered to the consumer at the initial price with the vendor absorbing the loss. This can occur if the price of the item was subject to a net increase between the time the item was added to a watch list and the time a consumer decided to finalize a transaction for the watch list. The consumer is thereby provided with an added incentive to buy from the vendor's website and to pay at least a portion of the item's price in advance if the “autobuy” option is selected. For example, a consumer created a watch list containing an item with an initial price of $50.00 and a target price of $40.00, and the consumer specified the “autobuy” option for the item. The price of the item increases to $60.00. If the consumer decides to finalize the transaction for the watch list, the total amount due for the item will be $10.00 ($50.00 for the item−$40.00 already paid). Alternatively, it is contemplated that the price assurance feature can be omitted and the balance due from the consumer can be equal to the difference between the increased price of the item and the amount of any payment previously made. It is further contemplated that the price assurance feature can be provided for items for which the “autobuy” option is selected but not for items for which the “notify” option is selected.

Layaway

The methods enabled by the Layaway module of the present invention allow a consumer to arrange a customized payment schedule for purchasing items through a vendor's e-commerce website. A consumer can pay for a transaction with a plurality of installment payments and can define the frequency and amount of the installments as well as the payment method used for each installment. Once a transaction is fully paid for, the items purchased in the transaction are processed and shipped.

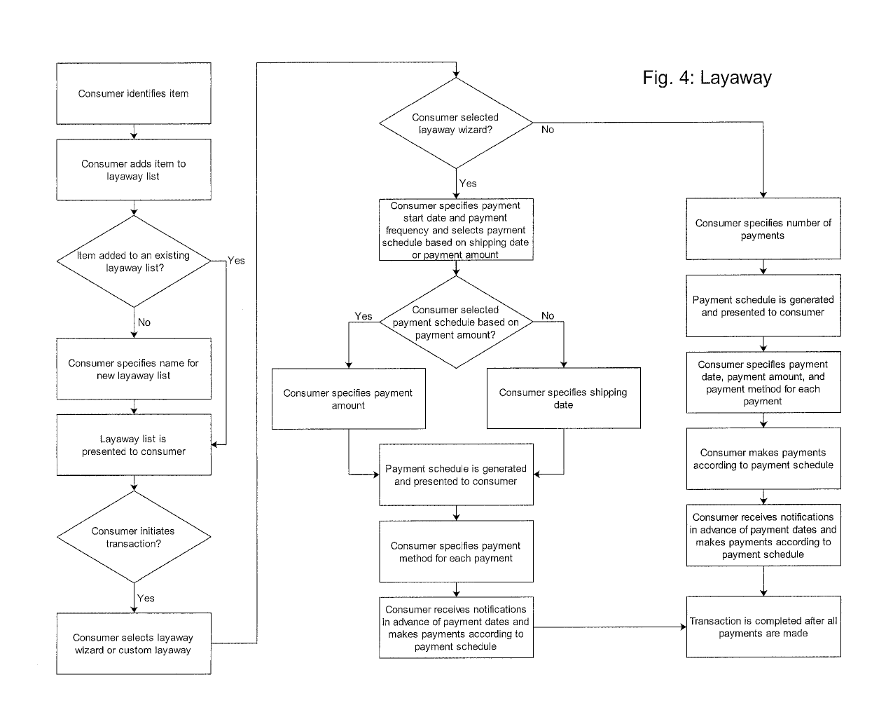

Referring to the flowchart shown in FIG. 4, to utilize the Layaway module a consumer first identifies an item on the vendor's website for which the consumer would like to schedule payment and shipping dates, such as an item displayed as part of the vendor's inventory, or an item in the consumer's shopping cart, delay delivery list, watch list, or gift list (described below). The consumer instructs the vendor's website to add the specified item to a “layaway list” (defined below), such as by selecting an option labeled “add to new Layaway list” or some variation thereof in a drop down menu adjacent the item (preferably the same drop down menu that offers the “add to shopping cart,” “add to new Delay Delivery List,” and “add to Watch List” options described above). The consumer is then asked to enter a reference name for a new layaway list (e.g., “Kitchen Appliances,” “Big Screen TV,” “New Work Outfit,” etc). Alternatively, the consumer can add the specified item to an existing layaway list, such as by selecting the name of a previously established layaway list from the same drop down menu described above.

A “layaway list” is a group of one or more items offered by the vendor that the consumer would like to purchase in a single transaction using a series of two or more installment payments. A consumer can create multiple different layaway lists for managing the payments for a plurality of different transactions. Each layaway list is maintained on the vendor website's host server in association with a particular consumer's user account.

The specified item is added to the layaway list designated by the consumer, and the consumer is presented with a separate page of the vendor's website on which any newly added and preexisting items associated with the designated layaway list are displayed. The web page preferably also displays the price of each item, as well the total price for all of the items on the list. The consumer is presented with the option of returning to a web page displaying the inventor's inventory (e.g., to continue shopping), such as by clicking a hyperlink labeled “Continue Shopping,” “Return,” or some variation thereof.

Alternatively, the consumer can initiate a transaction to purchase the items in the layaway list by selecting one of two layaway payment options. A first of the options, hereafter referred to as “layaway wizard” for convenience, allows the consumer to establish a uniformly structured payment plan based on several parameters defined by the consumer. The second layaway payment option, hereafter referred to as “custom layaway” for convenience, allows the consumer to establish a fully customized payment scheme that may include an irregular payment schedule or payment amount.

If the consumer chooses to initiate a transaction using the layaway wizard, such as by clicking a hyperlink labeled “Layaway Wizard” or some variation thereof, the consumer is instructed to enter or verify a shipping address for the transaction and to select a desired shipping method. The consumer is also instructed to enter any applicable promotional codes or coupon codes for the transaction, after which a grand total amount for the transaction is calculated and presented to the consumer.

The consumer is next asked to specify a “start date” on which he or she would like to begin making payments for the transaction, such as by instructing the consumer to type the start date into a designated field on the web page, or click a date on a conventional calendar applet on the web page. The consumer is then asked to specify a desired payment frequency (i.e., how often the consumer would like to make installment payments for the transaction), such as by selecting a time period (e.g., 1 week, 2 weeks, 3 weeks, 1 month, 2 months, 3 months) from a drop down menu on the web page, or by entering a time period into a designated field on the web page.

The consumer is next asked whether he or she would like to create a payment schedule based on a payment amount (i.e., the amount of each installment payment) or based on a shipping date. If the consumer chooses to create a payment schedule based on a payment amount, such as by clicking a hyperlink labeled “Payment Amount” or some variation thereof, the consumer is instructed to specify a desired payment amount, such as by entering the amount into a designated field on the web page.

After the consumer specifies a payment amount, the Layaway module calculates the amount of time it will take for the consumer to pay the total amount due on the transaction, such as by using the equation t=(ceiling(T÷P)−1)×F, where t equals the amount of time, T equals total amount due on the transaction, P equals the payment amount specified by the consumer, and F equals the payment frequency specified by the consumer. The term “ceiling” in the equation denotes the “ceiling function,” indicating that the product of (T÷P) is rounded up to the nearest integer. The amount of time (t), taken from the payment start date specified by the consumer, is used by the Layaway module to establish a shipping date for the transaction. The shipping date is preferably the day on which the final payment for the transaction is due or any day thereafter as dictated by the vendor.

For example, if the total amount due on a transaction is $400.00 and the consumer specifies a payment amount of $50 and a payment frequency of 2 weeks, the items on the relevant layaway list will be shipped 14 weeks after the payment start date specified by the consumer or sometime thereafter. If the total amount due on the transaction is not divisible by the specified payment amount, then the amount of the final payment due from the consumer is equal to the balance due on the transaction after the penultimate payment (in the specified payment amount) is made. Thus, if the total amount due on the transaction in the example above were $423.71 and the specified payment amount and payment frequency were the same, then the consumer would be required to make 8 payments of $50.00 and 1 final payment of $23.71, and the items in the transaction would be shipped 15 weeks after the payment start date or sometime thereafter.

After the shipping date is established, it is presented to the consumer for review. The consumer is preferably provided with an opportunity to modify the payment amount if he or she so desires, in which case a new shipping date will be established in the manner described above.

Alternatively, if the consumer chooses to specify a shipping date instead of a payment amount, such as by clicking a hyperlink labeled “Shipping Date” or some variation thereof on the web page displaying the designated layaway list, then the consumer is instructed to enter or verify a shipping address for the transaction and to select a desired shipping method. The consumer is also instructed to enter any applicable promotional codes or coupon codes for the transaction, after which a grand total amount for the transaction is calculated and presented to the consumer.

Next, the consumer is require to specify a date on which he or she would like the items on the layaway list to be shipped, such as by entering the date into a designated field on the web page, or by clicking the date on a conventional calendar applet on the web page. After the consumer specifies a shipping date, the Layaway module calculates a payment amount that will allow the consumer to pay the full amount due on the transaction on or before the specified shipping date, such as by using the equation P=T÷((t÷F)+1), where P equals the payment amount, T equals the total amount due on the transaction, t equals the amount of time between the start date and the specified shipping date, and F equals the payment frequency specified by the consumer. For example, if the total amount due on a transaction is $423.71 and the consumer specifies a payment frequency of 2 weeks and a shipping date that is 14 weeks from the payment start date specified by the consumer, the payment amount will be $52.96.

After the payment amount is calculated, it is presented to the consumer for review. The consumer is preferably provided with an opportunity to modify the shipping date if he or she so desires. If the consumer modifies the date, a new payment amount will be established in the manner described above.

After the consumer has indicated that he or she is satisfied with the payment amount and corresponding shipping date (established through either of the methods described above), such as by clicking a hyperlink link labeled “Continue” or some variation thereof, the consumer is presented with a payment schedule that includes a series of payment dates and corresponding payment amounts. For example, if the total amount due on a transaction is $168.56 and the consumer specifies a payment frequency of 1 week, a payment amount of $75.00, and a payment start date of December 3, the consumer will be presented with the following payment schedule (preferably presented in chart form): $75 due on December 3; $75.00 due on December 10; and $18.56 due on December 17.

Next, the consumer is instructed to specify a payment method for each payment amount in the payment schedule, such as by selecting a payment method from a drop down menu positioned adjacent each of the payment amounts on the web page. In the example above, for instance, a consumer may specify that he or she would like to pay the first payment of $75.00 with a credit card, the second payment of $75.00 with an ACH transfer, and the final payment of $18.56 with cash. The payments will then be processed on the established payment dates in the manner described in the Secure Pay section above, and the items in the relevant layaway list will subsequently be shipped on the specified or established shipping date. For example, the consumer will be instructed to enter credit card information for all payment amounts he or she selected to pay by credit card, and will be instructed to print and/or download payment forms for all payment amounts he or she selected to pay with cash.

If the consumer chooses to initiate a transaction for the items on the designated layaway list using the custom layaway option instead of the layaway wizard, such as by clicking a hyperlink labeled “Custom Layaway” or some variation thereof, the consumer is instructed to enter a shipping address for the transaction and select a desired shipping method. The consumer is also instructed to enter any applicable promotional codes or coupon codes for the transaction, after which a grand total amount for the transaction is calculated and presented to the consumer.

The consumer is next required to specify the total number of installment payments he or she would like to make for the transaction, such as by instructing him to enter the number in a designated field on the web page, or select a number from a drop down menu on the web page. The consumer may enter any integer he or she would like, with lower and upper limits established by the vendor.

The consumer is presented with a payment schedule that includes a number of payments equal to the number of payments specified by the consumer. The payment schedule is similar to the payment schedule provided by the layaway wizard described above, but the payment amounts and the dates on which the payment amounts are due are not specified, and the dates of these payments are preferably represented by blank fields on the web page. The consumer is then instructed to specify payment dates for the corresponding payment amounts. The consumer then does so, such as by clicking dates on conventional calendar applets and entering payment amounts into designated fields. Preferably, the total amount due on the transaction is displayed on the web page and is reduced by the amount of each payment amount entered by the consumer. For example, the total amount due on a transaction is $127.98 and the consumer has specified that he or she would like to pay the amount due in 4 payments. If the consumer specifies a first payment amount of $50.00, the displayed total amount due will then be $77.98. If the consumer then enters a second payment amount of $25.00, the displayed total amount due will then be $52.98. If the consumer then enters a third payment amount of $25.00, the Layaway module will preferably automatically enter the remaining $27.98 for the fourth and final payment amount and the displayed total amount due will then be $0.00.

The consumer is subsequently instructed to specify a payment method for each payment amount in the payment schedule, such as by presenting a payment method on a drop down menu positioned adjacent each of the payment amounts on the web page as with the layaway wizard described above. The payments selected will be processed on the specified payment dates in the manner described in the Secure Pay section above, and the items in the relevant layaway list will subsequently be shipped on the date of the final payment amount or some time thereafter.

A consumer can access and edit any of his or her established layaway lists at any time before the items on a list are processed and shipped, such as by logging into his or her online user account with a vendor and clicking on a hyperlink labeled “View Layaway Lists” or some variation thereof. For example, a consumer can add or remove items from a list or delete a list altogether thereby terminating the transaction associated with the list. If a consumer deletes a layaway list after any payments for the list's associated transaction have already been processed, the amounts paid are preferably refunded to the consumer without penalty. If a consumer adds or removes items from a layaway list for which a transaction has already been initiated, the total amount due on the transaction will be adjusted accordingly, and the consumer will be instructed to reconfigure the payment schedule for the transaction (using either of the layaway wizard or custom layaway options as described above). For example, if the consumer adds an item to a layaway list for which a transaction has already been initiated, the consumer may increase the amounts of existing scheduled payments or may add additional payments to the schedule in order to pay for the added item.

Additionally, a consumer can change the payment dates, shipping date, payment methods, and shipping method associated with a layaway list. For example, if a consumer has initiated a transaction using the custom layaway option described above, the consumer can freely modify the payment dates and corresponding payment amounts and methods for any outstanding payments. In another example, if a consumer has initiated a transaction using the layaway wizard described above, the consumer can modify a previously established payment amount or shipping date, in which case the Layaway module then calculates a new shipping date or payment amount, respectively, in the manner described above.

A consumer can preferably also instruct the Layaway module to issue notifications on or in advance of scheduled payment and shipping dates via specified forms of communication, such as by e-mail, text message, instant message, fax, or desktop widget (in which case the user will be provided with a conventional, downloadable widget application that communicates directly with the Layaway module, and preferably the same widget application described above).

A further aspect of the Layaway module of the present invention allows a consumer to take advantage of price reductions for items in his or her layaway lists before such items are shipped. For example, if the methods enabled by the Layaway module are incorporated into a single-vendor website, the website will continuously or periodically monitor the prices of items offered on the vendor's website that are in a consumer's layaway list. If the methods enabled by the Layaway module are incorporated into an aggregator website, the website continuously or periodically “crawls” the Internet in a conventional manner and monitors the prices of items offered through other e-commerce websites and preferably e-commerce websites belonging to merchants that are affiliates of the vendor, that are in a consumer's delay delivery list.

If the price of an item in a consumer's layaway list is reduced on either the vendor's website or an affiliate's website at any time after the item is added to the layaway list but before the specified shipping date (or before some time prior to the specified shipping date, as dictated by the vendor) then the price of the item in the consumer's layaway list is reduced by the same amount, and the payment schedule for the corresponding layaway list is reconfigured accordingly. For example, if a consumer creates a layaway list using the “layaway wizard” option and the price of an item on the list subsequently decreases, the payment amounts or payment dates for the list's associated transaction will be recalculated in the manner described above using the item's new, lower price. Alternatively, if a consumer creates a layaway list using the “custom layaway” option and the price of an item on the list subsequently decreases, the consumer will be invited to restructure his or her payment schedule in the manner described above to pay the new, lower total amount due for the transaction.

Gift Registry

The methods enabled by the Gift Registry module of the present invention allow a consumer to create one or more multiple gift registries and to manage various aspects of such registries, including, but not limited to the shipping dates of items in a registry and the allocation of contributed funds among items in a registry. The methods enabled by the Gift Registry module also allow those who contribute to a gift registry to contribute less than the full price of an item in a registry, or contribute a specified amount to a general fund for a registry which can then be allocated to various items in the registry by the registrant.

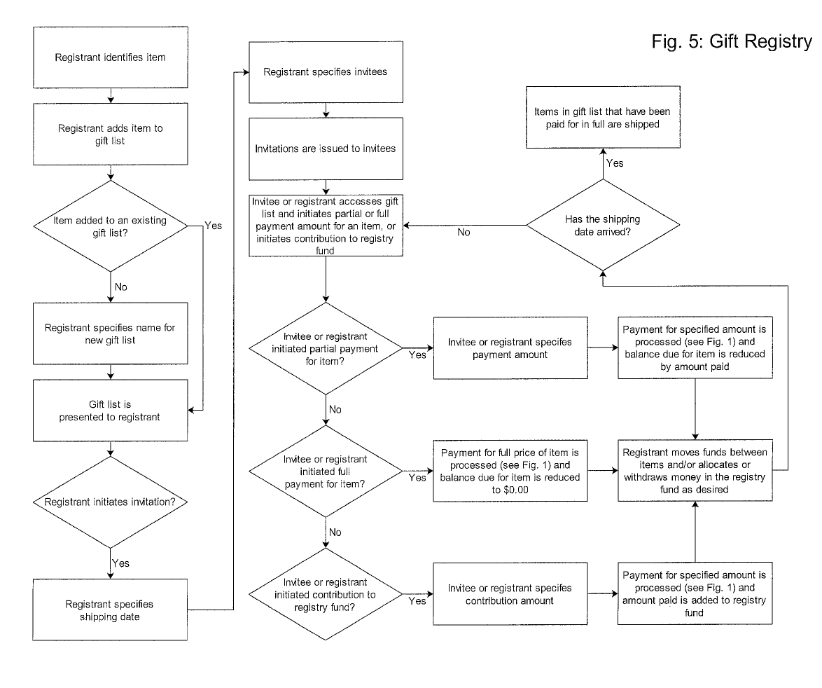

Referring to the flowchart in FIG. 5, to utilize the Gift Registry module a consumer (hereafter referred to as the “registrant”) first identifies an item on the vendor's website which the registrant would like to add to a gift registry, such as an item displayed as part of the vendor's publically accessible inventory, or an item in the registrant's shopping cart, delay delivery list, watch list, or layaway list (described above). The registrant then instructs the vendor's website to add the specified item to a “gift list” (defined below), such as by selecting an “add to new Gift list” option in a drop down menu adjacent the item (preferably the same drop down menu that offers the “add to shopping cart,” “add to new Delay Delivery list,” “add to new Watch list,” and “add to new Layaway list” options described above). The registrant is then asked to enter a reference name for a new gift list (e.g., “Wedding,” “Bridal Shower,” “Baby Shower,” etc.). Alternatively, the registrant can add the specified item to an existing gift list, such as by selecting the name of a previously established gift list from the same drop down menu described above.

A “gift list” is a group of one or more items offered by the vendor that the registrant desires to obtain as a gift. A registrant can create multiple different gift lists, each of which is maintained on the host server of the vendor's website in association with the registrant's user account.

The specified item is then added to the gift list designated by the registrant, and the registrant is forwarded to a separate page of the vendor's website where the newly added item, as well as any preexisting items associated with the designated gift list, are displayed. The web page preferably also displays the price of each item and the total price for all of the items on the gift list. The registrant is then presented with the option of returning to a web page displaying the inventor's inventory (e.g., to continue shopping), such as by clicking a hyperlink labeled “Continue Shopping,” “Return,” or some variation thereof. Alternatively, the consumer can instruct the Gift Registry module to issue a registry invitation to a select group of people (e.g., family, friends, and acquaintances), such as by clicking on a hyperlink labeled “Invite,” “Send Invitations” or some variation thereof.

If the registrant chooses to issue a registry invitation, the registrant is then instructed to specify a shipping address and shipping method for the items on the gift list. The registrant is also instructed to enter any applicable promotional codes or coupon codes for the transaction. The registrant is also instructed to specify a shipping date on which he or she would like the items in the gift list to be shipped.

The registrant is next instructed to enter the email addresses or other contact information of people (hereafter referred to as “invitees”) who the registrant wishes to invite to access the designated gift list, such as by entering the email addresses into designated fields on the web page. The registrant is preferably also provided an opportunity to enter a personalized message that will be included with the invitation. Once the registrant has entered the email addresses of all invitees, the registrant instructs the Gift Registry module to send the registry invitations, such as by clicking a hyperlink labeled “Send” or some variation thereof. The Gift Registry module then generates an email that contains, at a minimum, information identifying the registrant; a standard message or personalized message (if one was entered) inviting the email's recipient to access the designated gift list; and a hyperlink for accessing the designated gift list. The email preferably also contains a unique password for accessing the designated gift list.

Upon receiving a registry invitation, an invitee reviews the included message and clicks on the provided hyperlink. The invitee's web browser then automatically opens in a conventional manner, if it is not already open, and the invitee is taken to a web page where the invitee is instructed to enter the password described above for the designated gift list if such a password is required. After entering the correct password, the invitee is forwarded to a web page displaying the items in the registrant's designated gift list, including the price of each item. Alternatively, instead of accessing a registrant's gift list through a hyperlink in an invitation, it is contemplated that the invitee can instead visit the publically accessible web page of the vendor, search for the registrant's gift list (e.g., by providing the registrant's name), and enter the appropriate password to access the gift list. Still further, it is contemplated that a hyperlink to the registrant's gift list can be made available on a social networking website (e.g., Myspace, Facebook, Friendster, etc.), such as on a “profile page” maintained by the registrant on such a website.

Next, the invitee is presented with at least two payment options for each item on the gift list and a third payment option that applies to the gift list as a whole. A first of the payment options, hereafter referred to as “partial payment” for convenience, allows an invitee to pay only a portion of an item's full purchase price. A second of the payment options, hereafter referred to as “full payment” for convenience, allows an invitee to pay the full purchase price of an item. The third payment option, hereafter referred to as “fund payment” for convenience, allows an invitee to contribute a specified amount of money to a general “registry fund” instead of paying for (or toward) the purchase of a particular item.

If the invitee instructs the Gift Registry module to initiate a transaction for a particular item on the gift list using the “partial payment” option, such as by clicking on a hyperlink adjacent the item labeled “Partial Payment,” “Add Money,” “Add Funds,” or some variation thereof, the invitee is then instructed to specify an amount that he or she would like pay toward the item, such as by entering the amount into a designated field on the web page. The invitee is then forwarded to the payment processing portion of the vendor's website where a payment in the amount specified by the invitee is processed, preferably in the manner described in the Secure Pay section above.

Once the payment is fully processed, the purchase price of the item, as reflected in the designated gift list, is reduced by the amount paid by the invitee when it is displayed to later-viewing invitees. For example, if an invitee pays $60.00 toward a $100.00 coffee maker on a gift list using a credit card, the gift list will preferably then display the original $100.00 price of the coffee maker, a deduction of $60.00 representing the amount paid by the invitee (the identity of the invitee is preferably withheld from all but the registrant), and a remaining balance of $40.00. If a different invitee subsequently accesses the gift list, he or she may pay a portion of the remaining $40.00 balance for the coffee maker using the partial payment option in the manner described above, or may pay the entire balance for the coffee maker using the full payment option (described below).

If the invitee instructs the Gift Registry module to initiate a transaction for a particular item on the gift list using the “full payment” option (see above), such as by clicking on a hyperlink adjacent the item labeled “Full Payment,” “Purchase,” “Checkout,” or some variation thereof, the invitee is then forwarded to the payment processing portion of the vendor's website where a payment in the amount of the full purchase price of the item is processed, preferably in the manner described in the Secure Pay section above. Once the payment is fully processed, the item will preferably be marked as “paid” on the gift list, and invitees who subsequently access the gift list will not be presented with payment options for the item. Alternatively, purchased items can be hidden from all but the registrant.

If the invitee instructs the Gift Registry module to initiate a transaction using the “fund payment” option, such as by clicking on a hyperlink adjacent the item labeled “Fund Payment,” “Registry Fund,” or some variation thereof, the invitee is instructed to specify an amount that he or she would like contribute to the registry fund, such as by entering the amount into a designated field on the web page. The invitee is then forwarded to the payment processing portion of the vendor's website where a payment in the specified amount is processed in the manner described in the Secure Pay section above. Once the payment is fully processed, the amount of the payment is noted in association with the registrant's user account as an available balance with respect to the designated gift list. Each subsequent contribution to the registry fund by an invitee increases the available balance. The registrant can subsequently allocate the money in the registry fund to items in the gift list in any manner he or she desires, or can instead choose to receive the funds in registry fund in the form of a cash payment, check payment, bank transfer, or PayPal payment.

For example, a first invitee paid $60.00 toward to the purchase of a tea pot having a purchase price of $100.00 (using the partial payment option described above); a second invitee paid $20.00 toward to the purchase of a sandwich press having a purchase price of $60.00 (also using the partial payment option described above); and a third invitee contributed $60.00 to the registry fund for the gift list (using the fund payment option described above). The registrant may then allocate $40.00 of the registry fund to the remaining balance of the tea pot and $20.00 to the remaining balance of the sandwich press, thereby completing the purchase of the tea pot and reducing the remaining balance for the sandwich press to $20.00.

A registrant can access, edit, and manage any of his or her established gift lists at any time before the items on a list are processed and shipped, such as by logging into his or her online user account with a vendor and clicking on a hyperlink labeled “View Gift lists” or some variation thereof. For example, a registrant can add or remove items from a gift list, delete a gift list entirely, or change the shipping date and shipping method associated with a gift list. If a registrant deletes a gift list after any payments from invitees have already been processed, such payments are preferably refunded to the appropriate invitees without penalty, or added to the general registry fund, as designated.

Additionally, a registrant is provided with the same “partial payment” and “full payment” options described above. For example, if a registrant desires a refrigerator having a purchase price of $1000.00, but believes that invitees will be either unable or willing to pay the full price (individually or as a group), the registrant may use the partial payment option to reduce the balance for the refrigerator to a lower price that he or she believes the invitees will be able to meet. In another example, assume that invitees have paid $30.00 toward the purchase of a lamp having a full purchase price of $50.00. Assume also that the shipping date for the relevant gift list is drawing near and that the registrant does not foresee any further payments being made by invitees. The registrant may then use the full payment option to pay $20.00 to complete the purchase of the lamp.

A registrant can also instruct the Gift Registry module to shift funds between items on a gift list, such as by selecting an option labeled “Move Funds” or some variation thereof from a drop down menu adjacent a first item. This assumes some amount of money has previously been paid toward the first item using the partial payment option. If the registrant moves funds, the registrant is then asked to specify how much of the amount previously paid toward the item he or she would like to move. He or she could do so, such as by entering the amount into a designated field. The registrant is then asked to specify a second item on the gift list that he or she would like the specified amount to be applied to, and can do so by selecting an item from a drop down menu. Once the registrant has specified an amount and a second item, the specified amount is added back to the balance due for the first item and is deducted from the balance due for the second item.

For example, a first invitee paid $100.00 toward to the purchase of a china set having a purchase price of $200.00 (using the partial payment option described above) and that a second invitee paid $200.00 toward to the purchase of an espresso maker having a purchase price of $500.00 (also using the partial payment option described above). If the shipping date for the relevant gift list is drawing near and the registrant does not foresee any further payments being made by invitees, the registrant may allocate $100.00 of the $200.00 paid toward the purchase of the espresso maker to the remaining $100.00 balance for the china set. The purchase of the china set is thereby completed and the balance due for the espresso maker is increased to $400.00.

A registrant can also instruct the Gift Registry module to move an item from the gift list to a new or existing delay delivery list or a new or existing layaway list (described above), such as by selecting an option labeled “Move to Delay Delivery List” or an option labeled “Move to Layaway List” from a drop down menu adjacent the item. If the registrant does so, the item is then processed in the manner described in the Delay Delivery section above or the Layaway section above, with the amount due for completing the purchase of the item equal to the remaining balance for the item. The item is then removed from the gift list.

A registrant can also instruct the Gift registry module to issue notifications when payments and contributions are made by invitees. Such notifications are issued to the registrant via forms of communication specified by the registrant, such as by e-mail, text message, instant message, fax, or desktop widget. Such notifications preferably include the name of the invitee making the payment or contribution, the name of any item(s) being paid for or toward, and the amount of the payment or contribution made.

Upon the arrival of the specified shipping date for a gift list, all items on the gift list that have been purchased (i.e., the full purchase of the item has been paid) will be shipped to the shipping address specified by the registrant. The Gift Registry module preferably also issues a notification of shipment to the registrant (in the manner of issuing notifications described above) and provides the registrant with an opportunity to complete the purchase of any items having a remaining balance in any manner described in the Secure Pay, Delay Delivery, or Layaway sections above.

It is contemplated that a gift list can be established in a manner similar to that described above for the sole purpose of soliciting monetary contributions (i.e., as opposed to the solicitation of gift purchases), such as for a charity or for a college fund. In such a case, a registrant would not identify any items to be added to a gift list and all contributions from invitees would be made using the “fund payment” option described above.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for arranging payment by check for the purchase of at least one item offered by a vendor through an electronic commerce website, the method comprising:
(a) a consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

2. The method in accordance with claim 1, further comprising the website instructing the consumer to print the billing document and to deliver the billing document and said at least one check to the banking affiliate.

3. The method in accordance with claim 1, further comprising the banking affiliate notifying the vendor of the deposit.

4. A method for arranging payment by cash for the purchase of at least one item offered by a vendor through an electronic commerce website, the method comprising:
(a) a consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

5. The method in accordance with claim 4, further comprising the website instructing the consumer to print the payment form and to deliver the payment form and the cash payment to the cash processing agent.

6. The method in accordance with claim 4, further comprising the cash processing agent notifying the vendor of the payment.

7. A method for arranging payment for the purchase of at least one item offered by a vendor through an electronic commerce website, the method comprising:
(a) a consumer communicating to the website that the consumer will pay a total purchase price of said at least one item in a plurality of portions using at least two payment means;
(b) the consumer communicating to the website an amount of each portion of the total purchase price that the consumer will pay using each of said at least two payment means;
(c) the consumer paying each of the specified portions with said at least two payment means;
(d) a vendor shipping said at least one item after a sum of the specified portions paid is equal to at least the total purchase price.

8. The method in accordance with claim 7, further comprising:
(a) the consumer communicating to the website that the consumer will pay a specified portion by check;
(b) the website providing a billing document that contains information identifying a transaction to the consumer in an electronic format;
(c) the consumer printing and delivering the billing document and at least one check in the amount of the specified portion to a banking affiliate of the vendor; and
(d) the banking affiliate depositing the check into an account maintained by the vendor.

9. The method in accordance with claim 8, further comprising the website instructing the consumer to print the billing document and to deliver the billing document and said at least one check to the banking affiliate.

10. The method in accordance with claim 8, further comprising the banking affiliate notifying the vendor of the deposit.

11. The method in accordance with claim 7, further comprising:
(a) the consumer communicating to the website that the consumer will pay a specified portion by cash;
(b) the website providing a payment form that contains information identifying a transaction to the consumer in an electronic format;
(c) the consumer printing and delivering the payment form and a cash payment in the amount of the specified portion to a specified cash processing agent; and
(d) the cash processing agent crediting an account maintained by the vendor with the cash payment.

12. The method in accordance with claim 11, further comprising the website instructing the consumer to print the payment form and to deliver the payment form and the cash payment to the cash processing agent.

13. The method in accordance with claim 11, further comprising the cash processing agent notifying the vendor of the payment.

14. A method for arranging a purchase and shipment of at least one item, the method comprising:
(a) on a first date, a consumer specifying a second, later date on which the consumer will pay for said at least one item;
(b) the consumer specifying a third date on which a vendor must ship said at least one item;
(c) the consumer paying for said at least one item on the second date; and
(d) the vendor shipping said at least one item on the third date
wherein the first date is before the third date.

15. The method in accordance with claim 14, further comprising the vendor monitoring a price of said at least one item and reducing an amount of a payment due from the consumer if the price decreases between the first date and the second date.

16. The method in accordance with claim 14, further comprising the vendor monitoring a price of said at least one item and issuing a refund to the consumer if the price decreases between the second date and the third date, wherein the refund is equal to the difference between the price and the amount paid by the consumer on the second date.

17. A method for arranging a purchase and shipment of at least one item offered through an electronic commerce website, the method comprising:
(a) on a first date, a consumer communicating to the website a second, later date on which the consumer will pay for said at least one item;
(b) the consumer communicating to the website a third date on which a vendor must ship said at least one item;
(c) the consumer paying for said at least one item on the second date; and
(d) the vendor shipping said at least one item on the third date
wherein the first date is different from the third date.

18. The method in accordance with claim 17, further comprising the website notifying the consumer that payment is due.

19. The method in accordance with claim 17, wherein the step of the consumer paying for said at least one item on the second date comprises:
(a) the consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

20. The method in accordance with claim 19, further comprising the website instructing the consumer to print the billing document and to deliver the billing document and said at least one check to the banking affiliate.

21. The method in accordance with claim 19, further comprising the banking affiliate notifying the vendor of the deposit.

22. The method in accordance with claim 17, wherein the step of the consumer paying for said at least one item on the second date comprises:
(a) the consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

23. The method in accordance with claim 22, further comprising the website instructing the consumer to print the payment form and to deliver the payment form and the cash payment to the cash processing agent.

24. The method in accordance with claim 22, further comprising the cash processing agent notifying the vendor of the payment.

25. The method in accordance with claim 17, further comprising the website crawling the Internet to monitor a price of said at least one item and reducing an amount of a payment due from the consumer if the price decreases between the first date and the second date.

26. The method in accordance with claim 17, further comprising the website crawling the Internet to monitor a price of the item and issuing a refund to the consumer if the price decreases between the second date and the third date, wherein the refund is equal to the difference between the price and the amount paid by the consumer on the second date.

27. A method for arranging a purchase of at least one item that is offered for sale at a first price, the method comprising:
(a) a consumer specifying a second price that is less than the first price;
(b) the consumer providing a means for paying the second price;
(c) a vendor monitoring a current price of said at least one item;
(d) the vendor purchasing said at least one item for the consumer with the payment means provided by the consumer if the current price becomes no greater than the second price; and
(e) the vendor shipping said at least one item to the consumer.

28. The method in accordance with claim 27, further comprising notifying the consumer if the current price of said at least one item changes.

29. The method in accordance with claim 27, further comprising the vendor issuing a refund to the consumer if the current price is less than the second price, wherein the refund is equal to the difference between the current price and the second price.

30. A method for arranging a purchase of at least one item that is offered for sale at a first price, the method comprising:
(a) a consumer specifying a second price that is less than the first price;
(b) a vendor monitoring a current price of the item; and
(c) the vendor notifying the consumer if the current price of said at least one item becomes no greater than the second price.

31. The method in accordance with claim 30, further comprising notifying the consumer if the current price of said at least one item becomes less than the first price but more than the second price.

32. A method for arranging a purchase of at least one item offered through an electronic commerce website wherein said at least one item is offered for sale at a first price, the method comprising:
(a) a consumer communicating to the website a second price that is less than the first price;
(b) the consumer providing a means for paying the second price;
(c) the website crawling the Internet to monitor a current price of said at least one item;
(d) the website purchasing said at least one item for the consumer with the payment means provided by the consumer if the current price becomes no greater than the second price; and
(e) a vendor shipping said at least one item to the consumer.

33. The method in accordance with claim 32, further comprising the website notifying the consumer if the current price of said at least one item become less than the first price but more than the second price.

34. The method in accordance with claim 32, wherein the step of the consumer providing a means for paying the second price comprises:
(a) the consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

35. The method in accordance with claim 34, further comprising the website instructing the consumer to print the billing document and to deliver the billing document and said at least one check to the banking affiliate.

36. The method in accordance with claim 34, further comprising the banking affiliate notifying the vendor of the deposit.

37. The method in accordance with claim 32, wherein the step of the consumer providing a means for paying the second price comprises:
(a) the consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

38. The method in accordance with claim 37, further comprising the website instructing the consumer to print the payment form and to deliver the payment form and the cash payment to the cash processing agent.

39. The method in accordance with claim 37, further comprising the cash processing agent notifying the vendor of the payment.

40. The method in accordance with claim 32, further comprising the website issuing a refund to the consumer if the current price is less than the second price, wherein the refund is equal to the difference between the current price and the second price.

41. A method for arranging a purchase of at least one item offered through an electronic commerce website wherein said at least one item is offered for sale at a first price, the method comprising:
(a) a consumer communicating to the website a second price that is less than the first price;
(b) the website monitoring a current price of the item; and
(c) the website notifying the consumer if the current price of said at least one item becomes no greater than the second price.

42. The method in accordance with claim 41, further comprising the website notifying the consumer if the current price of said at least one item becomes less than the first price but more than the second price.

43. A method for arranging installment payments for a purchase of at least one item, the method comprising:
(a) a consumer specifying:
i. a first date on which the consumer will begin paying for said at least one item;
ii. a second, later date on which a vendor must ship said at least one item; and
iii. a payment frequency, f with which the consumer will make installment payments;
(b) calculating an installment payment amount, P that allows the consumer to pay a total purchase price, T of said at least one item in a time period, t between and including the first date and the second date;
(c) presenting to the consumer a payment schedule that instructs the consumer to make installment payments in the payment amount, P on the first date and with the payment frequency, f thereafter;
(d) the consumer making payments according to the payment schedule; and
(d) the vendor shipping said at least one item on the second date.

44. A method for arranging installment payments for a purchase of at least one item, the method comprising:
(a) a consumer specifying:
i. a first date on which the consumer will begin paying for said at least one item;
ii. an installment payment amount, P; and
iii. a payment frequency, f with which the consumer will make installment payments;
(b) calculating an amount of time, t it will take for the consumer to pay a total purchase price, T of said at least one item;
(c) presenting to the consumer a payment schedule that instructs the consumer to make installment payments in the payment amount, P on the first date and with the payment frequency, f thereafter until, but not including, a second date that is removed from the first date by the amount of time, t, and that instructs the consumer to make a final installment payment on the second date in an amount equal to the total purchase price, T reduced by a sum of the installment payments that are to be paid before the second date;
(d) the consumer making payments according to the payment schedule; and
(e) a vendor shipping said at least one item after the final installment payment is made.

45. A method for arranging installment payments for a purchase of at least one item, the method comprising:
(a) a consumer specifying a payment schedule including:
i. a total number of installment payments that the consumer will make to pay for said at least one item;
ii. a payment date for each of the total number of installment payments;
iii. a payment amount for each of the total number of installment payments, wherein a sum of all the payment amounts equals a total purchase price of said at least one item; and
iv. a payment method for each of the total number of installment payments;
(b) the consumer making payments according to the payment schedule; and
(c) a vendor shipping said at least one item after all of the total number of installment payments have been received.

46. A method for arranging installment payments for a purchase of at least one item offered through an electronic commerce website, the method comprising:
(a) a consumer communicating to the website:
i. a first date on which the consumer will begin paying for said at least one item;
ii. a second, later date on which a vendor must ship said at least one item; and
iii. a payment frequency, f with which the consumer will make installment payments;
(b) the website calculating an installment payment amount, P that allows the consumer to pay a total purchase price, T of said at least one item in a time period, t between and including the first date and the second date;
(c) the website presenting to the consumer a payment schedule that instructs the consumer to make installment payments in the payment amount, P on the first date and with the payment frequency, f thereafter;
(d) the consumer making payments according to the payment schedule; and
(e) the vendor shipping said at least one item on the second date.

47. The method in accordance with claim 46, further comprising the website notifying the consumer that an installment payment is due.

48. The method in accordance with claim 46, further comprising the consumer communicating to the website a payment method that the consumer will use to pay each installment payment.

49. The method in accordance with claim 46, further comprising:
(a) the consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

50. The method in accordance with claim 49, further comprising the website instructing the consumer to print the billing document and to deliver the billing document and said at least one check to the banking affiliate.

51. The method in accordance with claim 49, further comprising the banking affiliate notifying the vendor of the deposit.

52. The method in accordance with claim 46, further comprising:
(a) the consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

53. The method in accordance with claim 52, further comprising the website instructing the consumer to print the payment form and to deliver the payment form and the cash payment to the cash processing agent.

54. The method in accordance with claim 52, further comprising the cash processing agent notifying the vendor of the payment.

55. A method for arranging installment payments for a purchase of at least one item, the method comprising:
(a) a consumer specifying:
i. a first date on which the consumer will begin paying for said at least one item;
ii. an installment payment amount, P; and
iii. a payment frequency, f with which the consumer will make installment payments;
(b) calculating an amount of time, t it will take for the consumer to pay a total purchase price, T of said at least one item;
(c) presenting to the consumer a payment schedule that instructs the consumer to make installment payments in the payment amount, P on the first date and with the payment frequency, f thereafter until, but not including a second date that is removed from the first date by the amount of time, t, and that instructs the consumer to make a final installment payment on the second date in an amount equal to the total purchase price, T reduced by a sum of the installment payments that are to be paid before the second date;
(d) the consumer making payments according to the payment schedule; and
(e) a vendor shipping said at least one item on the second date.

56. The method in accordance with claim 55, further comprising the website notifying the consumer that an installment payment is due.

57. The method in accordance with claim 55, further comprising the consumer communicating to the website a payment method that the consumer would like to use to pay each installment payment.

58. The method in accordance with claim 55, further comprising:
(a) the consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

59. The method in accordance with claim 58, further comprising the website instructing the consumer to print the billing document and to deliver the billing document and said at least one check to the banking affiliate.

60. The method in accordance with claim 58, further comprising the banking affiliate notifying the vendor of the deposit.

61. The in accordance with claim 55, further comprising:
(a) the consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

62. The method in accordance with claim 61, further comprising the website instructing the consumer to print the payment form and to deliver the payment form and the cash payment to the cash processing agent.

63. The method in accordance with claim 61, further comprising the cash processing agent notifying the vendor of the payment.

64. A method for arranging installment payments for a purchase of at least one item offered through an e-commerce website, the method comprising:
(a) a consumer communicating to the website a payment schedule including:
i. a total number of installment payments that the consumer will make to pay for said at least one item;
ii. a payment date for each of the total number of installment payments;
iii. a payment amount for each of the total number of installment payments, wherein a sum of all the payment amounts equals a total purchase price of said at least one item; and
iv. a payment method for each of the total number of installment payments;
(b) the consumer making payments according to the payment schedule; and
(c) a vendor shipping said at least one item after all of the total number of payments have been received.

65. The method in accordance with claim 64, further comprising the website notifying the consumer that an installment payment is due.

66. The method in accordance with claim 64, wherein the step of the consumer specifying a payment method for each of the total number of installment payments comprises:
(a) the consumer communicating to the website that the consumer will make a payment in a specified amount by check;
(b) the website providing a billing document that contains information identifying a transaction to the consumer in an electronic format;
(c) the consumer printing and delivering the billing document and at least one check in the specified amount to a banking affiliate of the vendor; and
(d) the banking affiliate depositing the check into an account maintained by the vendor.

67. The method in accordance with claim 66, further comprising the website instructing the consumer to print the billing document and to deliver the billing document and said at least one check to the banking affiliate.

68. The method in accordance with claim 66, further comprising the banking affiliate notifying the vendor of the deposit.

69. The method in accordance with claim 64, wherein the step of the consumer specifying a payment method for each of the total number of installment payments comprises:
(a) the consumer communicating to the website that the consumer will make a payment in a specified amount by cash;
(b) the website providing a payment form that contains information identifying a transaction to the consumer in an electronic format;
(c) the consumer printing and delivering the payment form and a cash payment in the specified amount to a specified cash processing agent; and
(d) the cash processing agent crediting an account maintained by the vendor with the cash payment.

70. The method in accordance with claim 69, further comprising the website instructing the consumer to print the payment form and to deliver the payment form and the cash payment to the cash processing agent.

71. The method in accordance with claim 69, further comprising the cash processing agent notifying the vendor of the payment.

72. A method for establishing and managing a gift registry with a vendor, the method comprising:
(a) a registrant identifying at least one item as a desired gift;
(b) the registrant specifying a shipping date on which the vendor must ship said at least one item;
(c) the registrant specifying a plurality of invitees;
(d) issuing invitations to the invitees to participate in the gift registry;
(e) at least one of the invitees paying an amount as a payment toward the purchase of said at least one item;
(f) decreasing the purchase price of said at least one item by an amount of any payments made toward the purchase of said at least one item and displaying the decreased purchase price to the invitees; and
(g) the vendor shipping said at least one item on the shipping date if a sum of all payments made toward the purchase of said at least one item is equal to at least the purchase price of said at least one item.

73. The method in accordance with claim 72, further comprising at least one invitee contributing money to a general registry fund.

74. The method in accordance with claim 73, further comprising the registrant allocating at least a portion of any money in the general registry fund to a payment toward the purchase of said at least one item.

75. The method in accordance with claim 73, further comprising the registrant receiving money in the general registry fund in the form of a monetary payment.

76. The method in accordance with claim 72, further comprising the registrant paying an amount toward the purchase of said at least one item.

77. The method in accordance with claim 72, further comprising:
(a) the registrant allocating at least a portion of any amount previously paid toward the purchase of a first of said at least one item to a payment toward the purchase of a second of said at least one item;
(b) increasing the purchase price of the first item by the amount allocated and displaying the increased purchase price to the invitees; and
(c) decreasing the purchase price of the second item by the amount allocated and displaying the decreased purchase price to the invitees.

78. The method in accordance with claim 72, further comprising the registrant receiving payments made toward the purchase of said at least one item in the form of a monetary payment.

79. A method for establishing and managing a gift registry with an electronic commerce website, the method comprising:
(a) a registrant identifying to the website at least one item as a desired gift;
(b) the registrant specifying to the website a shipping date on which said at least one item must be shipped;
(c) the registrant specifying to the website a plurality of invitees;
(d) the website issuing invitations to the invitees to participate in the gift registry;
(e) at least one of the invitees paying an amount toward the purchase of said at least one item;
(f) the website decreasing the purchase price of said at least one item by an amount of any payments made toward the purchase of said at least one item and displaying the decreased purchase price to the invitees; and
(g) a vendor shipping said at least one item on the shipping date if a sum of all payments made toward the purchase of said at least one item is equal to at least the purchase price of said at least one item.

80. The method in accordance with claim 79, further comprising the website presenting at least one invitee contributing money to a general registry fund.

81. The method in accordance with claim 80, further comprising the registrant instructing the website to allocate at least a portion of any money in the general registry fund to a payment toward the purchase of said at least one item.

82. The method in accordance with claim 80, further comprising the registrant receiving money in the general registry fund in the form of a monetary payment.

83. The method in accordance with claim 79, further comprising the website presenting the registrant paying an amount toward the purchase of said at least on item.

84. The method in accordance with claim 79, further comprising:
(a) the registrant instructing the website to allocate at least a portion of any amount previously paid toward the purchase of a first of said at least one item to a payment toward the purchase of a second of said at least one item;
(b) the website increasing the purchase price of the first item by the amount allocated and displaying the increased purchase price to the invitees; and
(c) the website decreasing the purchase price of the second item by the amount allocated and displaying the decreased purchase price to the invitees.

85. The method in accordance with claim 79, further comprising the registrant receiving payments made toward the purchase of said at least one item in the form of a monetary payment.

86. The method in accordance with claim 79, further comprising:
(a) one of said invitees communicating to the website that the invitee will make a payment in a specified amount by check;
(b) the website providing a billing document that contains information identifying a transaction to the invitee in an electronic format;
(c) the invitee printing and delivering the billing document and at least one check in the specified amount to a banking affiliate of the vendor; and
(d) the banking affiliate depositing the check into an account maintained by the vendor.

87. The method in accordance with claim 86, further comprising the website instructing the consumer to print the billing document and to deliver the billing document and said at least one check to the banking affiliate.

88. The method in accordance with claim 86, further comprising the banking affiliate notifying the vendor of the deposit.

89. The method in accordance with claim 79, further comprising:
(a) one of said invitees communicating to the website that the invitee will make a payment in a specified amount by cash;
(b) the website providing a payment form that contains information identifying a transaction to the invitee in an electronic format;
(c) the invitee printing and delivering the payment form and a cash payment in the specified amount to a specified cash processing agent; and
(d) the cash processing agent crediting an account maintained by the vendor with the cash payment.

90. The method in accordance with claim 89, further comprising the website instructing the consumer to print the payment form and to deliver the payment form and the cash payment to the cash processing agent.

91. The method in accordance with claim 89, further comprising the cash processing agent notifying the vendor of the payment.
